(19) United States
(12) Patent Application Publication
(10) Pub. No.: US 2008/0039186 A1
(43) Pub. Date: Feb. 14, 2008

(54) Gaming machine and method for providing game

(75) Inventor: Yukinori Inamura, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 11/882,286

(22) Filed: Jul. 31, 2007

(30) Foreign Application Priority Data
Aug. 1, 2006 (JP) P2006-209862

(51) Int. Cl. A63F 9/24; A63F 13/00; A63F 13/10

(52) U.S. Cl. 463/20; 463/21; 463/26

(57) ABSTRACT

A gaming machine includes: a display; an operation unit that allows a player to input commands for playing a game; and a processor that is operable with the display and the operation unit to: control the display to display an arrangement of a plurality of symbols for providing the game, the symbols each belonging to one of a plurality of kinds; provide an award to the player when the arrangement is determined to be a combination including a predetermined number of symbols that belong to a kind that is defined as a specific symbol, the award having a detail being determined in accordance with the number of the symbols, which belong to the kind that is defined as the specific symbol, included in the arrangement; and change an upper limit of the number of the symbols when a predetermined condition is satisfied.

### CROSS-REFERENCE TO THE RELATED APPLICATION(S)

The present application is based upon and claims priority from prior Japanese Patent Application No. 2006-209862, filed on Aug. 1, 2006, the entire content of which are incorporated herein by reference.

### TECHNICAL FIELD

The present invention relates to a gaming machine and a method for paying out an award on the basis of the combination of arranged symbols. The present invention also relates to a gaming machine and a method for changing symbols to satisfy the combination to pay out the award when a predetermined condition is satisfied.

### BACKGROUND

Conventionally, a slot machine, which is one type of gaming machines, is configured such that the game is started by inserting a game medium such as a coin into the gaming machine. Thereafter, symbol columns are variably displayed in a predetermined area of the gaming machine and are displayed stopped after lapse of a predetermined time period. Then, a predetermined amount of the game medium is paid out on the basis of the stopped symbol combination.

As a device for variably displaying the symbol columns, a mechanical reel or a video reel is used. For example, U.S. Pat. No. 6,093,102 and U.S. Pat. No. 6,960,133 describe a slot machine displaying totally fifteen symbols arranged in 3×5 matrix by use of the video reel or the mechanical reel. In this slot machine, when the game is started, the reels rotate so that the symbols of the respective columns arranged in a vertical direction are started to be variably displayed, and so that three symbols are displayed stopped in the respective columns as the reels stop rotations after lapse of a predetermined time period. Then, the award is paid out when the symbols are stopped and displayed in a combination, in which a predetermined number or more of symbols of the same kind exist.

In the conventional slot machine described above, the combination to pay out the award was always the same. Specifically, when a predetermined number of specific symbols of the same kind are stopped and displayed in the display, the award to be paid out is determined based on the kinds (e.g., “CHERRY” or “7”) and the number (e.g., 3 to 10) of the symbols displayed. However, the upper limit (e.g., 10) of the number of the symbols to influence the kind of award or the amount of the award was predetermined in a fixed manner.

### SUMMARY

One of objects of the present invention is to provide a gaming machine and a method, which is enabled, by satisfying a predetermined condition, to satisfy a combination to pay out an award of a larger sum, so that a game attractive for the player can be provided to improve the expectation for the game.

According to a first aspect of the invention, there is provided a gaming machine including: a display; an operation unit that allows a player to input commands for playing a game; and a processor that is operable with the display and the operation unit to: control the display to display an arrangement of a plurality of symbols for providing the game, the symbols each belonging to one of a plurality of kinds; provide an award to the player when the arrangement is determined to be a combination including a predetermined number of symbol that belong to a kind that is defined as a specific symbol, the award having a detail being determined in accordance with the number of the symbols, which belong to the kind that is defined as the specific symbol, included in the arrangement; and change an upper limit of the number of the symbols when a predetermined condition is satisfied.

According to a second aspect of the invention, there is provided a method for providing a game to a player, the method including: allowing the player to input commands for playing the game; displaying an arrangement of a plurality of symbols for providing the game, the symbols each belonging to one of a plurality of kinds; providing an award to the player when the arrangement is determined to be a combination including a predetermined number of symbols that belong to a kind that is defined as a specific symbol, the award having a detail being determined in accordance with the number of the symbols, which belong to the kind that is defined as the specific symbol, included in the arrangement; and changing an upper limit of the number of the symbols when a predetermined condition is satisfied.

### BRIEF DESCRIPTION OF THE DRAWINGS

In the accompanying drawings:

FIG. 1 is a diagram showing the combinations to satisfy awards in a slot machine according to a first embodiment and the details of the awards;

FIG. 2 is a perspective view showing an appearance of the slot machine according to the first embodiment;

FIG. 3 is a front elevation view showing an award display screen to be displayed in an upper display;

FIG. 4 is a front elevation view showing a symbol display unit according to the first embodiment;

FIG. 5 is a front elevation view showing symbols to be displayed in the symbol display unit after reels are rotated;

FIG. 6 is a diagram showing the symbol display unit in a state, in which a player starts a game with 3-BET so that the symbols are stopped and displayed with the combination shown in FIG. 5;

FIG. 7 is a diagram showing the symbol display unit in a state, in which a player starts a game with 5-BET so that the symbols are stopped and displayed with the combination shown in FIG. 5;

FIG. 8 is an award table showing the awards to be paid out to the player on the basis of the combination of the symbols displayed in the symbol display unit;

FIG. 9 is a block diagram schematically showing a control system of the slot machine according to the first embodiment;

FIG. 10 is a flow chart of a main control program in the slot machine according to the first embodiment;

FIG. 11 is a flow chart of a main gaming program in the slot machine according to the embodiment;

FIG. 12 is a diagram showing the combinations for satisfying the awards in the slot machine according to a second embodiment, and the details of the awards; and

FIG. 13 is a diagram showing the combinations for satisfying the awards in the slot machine according to a third embodiment, and the details of the awards.

### DETAILED DESCRIPTION

A gaming machine according to the present invention is described in detail on first to third embodiments embodying the slot machine, with reference to the accompanying drawings. Here, the following slot machines according the first to third embodiments are the so-called “video slot machine”, which is provided with an image display device such as a liquid crystal display so that the games can be played by displaying images of various symbols in the image display device.

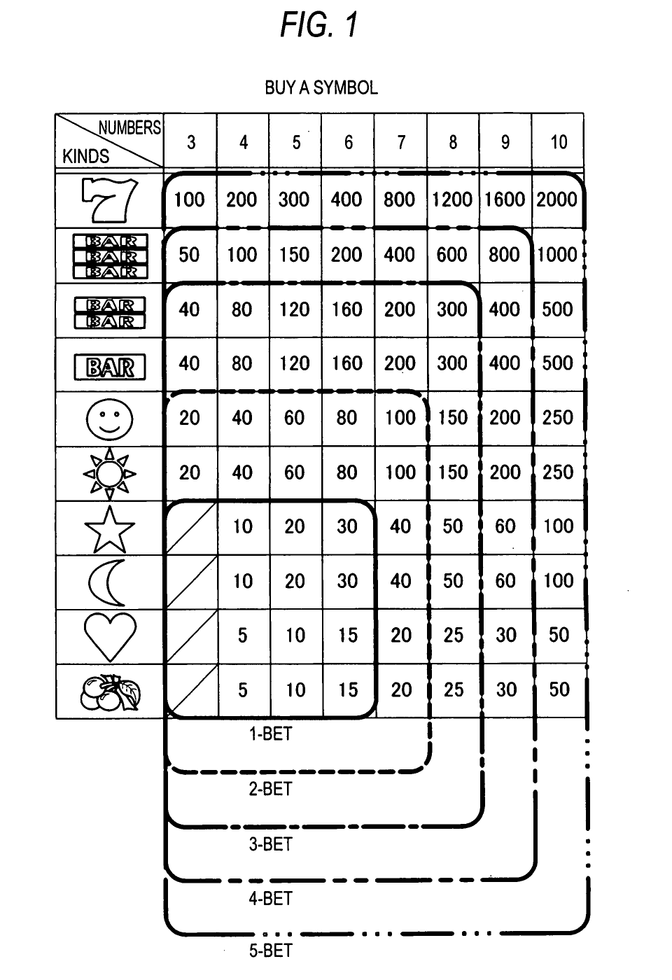

The slot machine according to the embodiments is characterized in that the award is paid out when symbols of the same kind are arranged in a predetermined number or more in the display, and in that the upper limit of symbols to influence the award increases as the bet number of the player at the start accepting time increases, as shown in FIG. 1.

When the bet number is 1-BET, for example, the credits to be paid out as the award are increased with the symbol number, until the number of the simultaneously displayed symbols is six at the maximum. When the bet number is 2-BET, the credits to be paid out as the award are increased with the symbol number, until the number of the simultaneously displayed symbols is seven at the maximum. When the bet number is 3-BET, the credits to be paid out as the award are increased with the symbol number, until the number of the simultaneously displayed symbols is eight at the maximum. When the bet number is 4-BET, the credits to be paid out as the award are increased with the symbol number, until the number of the simultaneously displayed symbols is nine at the maximum. When the bet number is 5-BET, the credits to be paid out as the award are increased with the symbol number, until the number of the simultaneously displayed symbols is ten at the maximum.

The slot machine according to the embodiments is characterized in that the kinds of symbols to be paid out for the awards increase as the bet number of the player at the start accepting time increases, as shown in FIG. 1. When the bet number is 1-BET, for example, four kinds of symbols of “CHERRY”, “HEART”, “MOON” and “STAR” are the targets. When the bet number is 2-BET, six kinds additionally having symbols of “SUN” and “SMILE” are the targets. When the bet number is 3-BET, eight kinds additionally having symbols of “1BAR” and “2BAR” are the targets. When the bet number is 4-BET, nine kinds additionally having a symbol of “3BAR” are the targets. When the bet number is 5-BET, ten kinds additionally having a symbol of “7” are the targets.

### FIRST EMBODIMENT

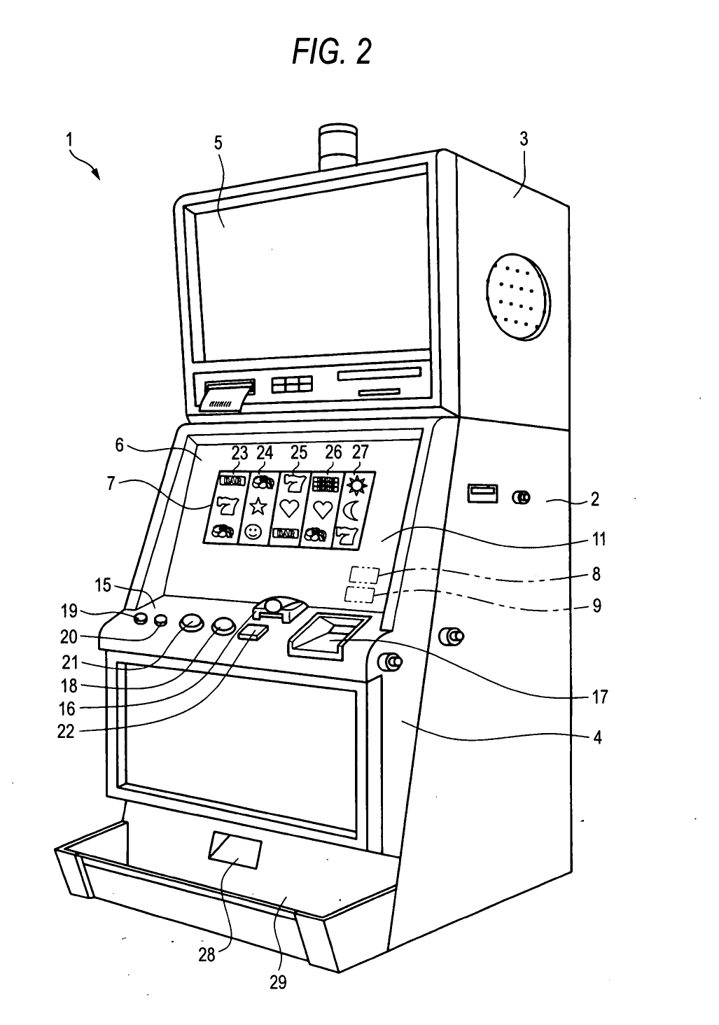

A schematic configuration of a slot machine 1 according to the first embodiment is described with reference to FIG. 2. FIG. 2 is a perspective view of the slot machine 1 according to the first embodiment.

The slot machine 1 according to the first embodiment is configured to include a cabinet 2, a top box 3 disposed on the upper side of the cabinet 2, and a main door 4 disposed on the front face of the cabinet 2.

The top box 3 is provided on its front face with an upper display 5. This upper display 5 is configured of the well-known liquid crystal display, and displays various information, such as a gaming method and an award table.

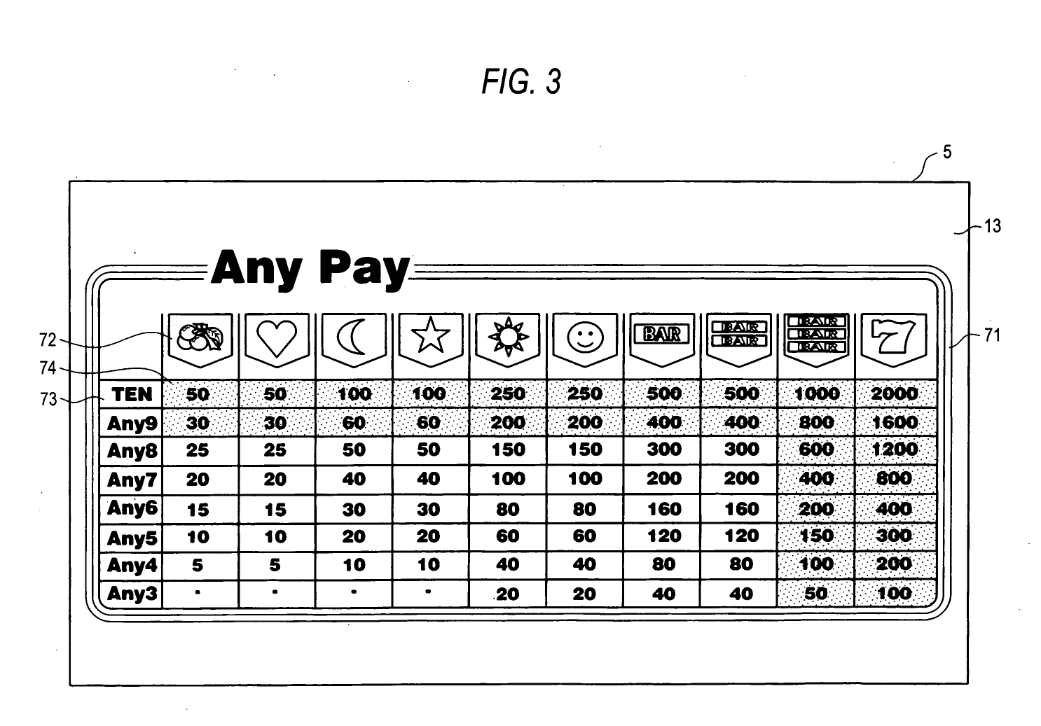

FIG. 3 is a diagram showing an example of an award display screen 13 to be displayed in the upper display 5. As shown in FIG. 3, the award display screen 13 is configured of an award table 71 arranged generally at the center, and shows the details of awards (i.e., the credit numbers to be paid out), which are given to correspond to the kinds and numbers of symbols stopped and displayed. Here, the award table 71 displays images 72 of symbols of ten kinds in the upper row, and images 73 of eight kinds indicating the number of symbols, in a leftmost column. Moreover, the numbers of credits to be paid out as the awards are individually displayed for award display areas 74 of the eighty portions, which are specified by the combinations of the kinds of symbols displayed in the upper row and the numbers of symbols displayed in the leftmost column. For example, the award table 71 shown in FIG. 3 indicates that 20 credits are paid out as the award when seven symbols of “CHERRY” are displayed independently of their display positions.

In the slot machine 1 of the first embodiment, the kinds of the symbols for the awards to be paid out and the upper limits of the symbol numbers to influence the awards increase, as the number bet by the player at the start accepting time increases. In the award display screen 13, therefore, only the award display area 74 for the payout target on the basis of the bet number being accepted is lightened by a backlight, whereas the award display area 74 not to become the payout target is extinguished (FIG. 3 shows the lightening state of the backlight when the bet number is 3-BET). As a result, the player can easily grasp the combination to be paid out at present and the details of the award.

The main door 4 is provided on its whole face with a lower display 6. This lower display 6 is configured as a well-known liquid crystal display, and is equipped with a symbol display unit 7 having 3×5 symbol display areas. This symbol display unit 7 is configured of five columns of reels 23 to 27. The reels 23 to 27 display to scroll the symbol columns of a predetermined array, and stop-display three symbols at the maximum after lapse of a predetermined time period. As a result, fifteen symbols are displayed at the maximum in accordance with the program of the game, as will be described hereinafter, so that a predetermined award is paid out to the player on the basis of the combination of symbols displayed. Here, the number of reels may be three, and the number of symbols to be displayed should not be limited to fifteen.

The lower display 6 is provided on its front face with a touch panel 11 so that the player can operate the touch panel 11 to input various instructions.

The lower display 6 is provided with a credit number display unit 8 and a payout number display unit 9. The credit number display unit 8 displays the number of credits owned at present by the player. The payout number display unit 9 displays, as a payout number, the sum of an award which is given when the combination of the symbols displayed stopped in the symbol display unit 7 is a predetermined winning combination.

Below the lower display 6, there are provided a control panel 15 having a plurality of buttons arranged for inputting the instructions relating to the game progress by the player, a coin receiving slot 16 for receiving the coin or the gaming medium into the cabinet 2, and a bill insertion slot 17.

The control panel 15 is provided with a start button 18, a change button 19, a CASHOUT button 20, a 1-BET button 21 and a MAX-BET button 22. The start button 18 serves as an operation unit for accepting instructions (commands) to start the scroll display of the symbol columns in the reels 23 to 27. The change button 19 is operation unit, which is used when an exchange is demanded for the clerk of a game arcade. The CASHOUT button 20 is operation unit for inputting either an instruction to pay out the coins corresponding to the credit number owned by the player (one credit corresponds to one coin), from a coin payout opening 28 to a coin tray 29, or an instruction to pay out a ticket with a bar code.

The 1-BET button 21 is operation unit for accepting an instruction to bet one of the credits owned by the player, on the game. On the other hand, the MAX-BET button 22 serves as the operation unit for accepting an instruction to bet the maximum value (e.g., 5 credits in the first embodiment), that can be bet on one game, of the credits owned by the player, on the game. Incidentally, another BET button can also be exemplified by other various BET buttons such as a 3-BET button.

In the slot machine 1 of the first embodiment, the gaming medium is exemplified by coins, paper currencies, or electronic valuable information (or credits) corresponding to them. However, the gaming medium to be applied to the invention should not be limited to those but can be exemplified by medals, tokens, electronic money or tickets.

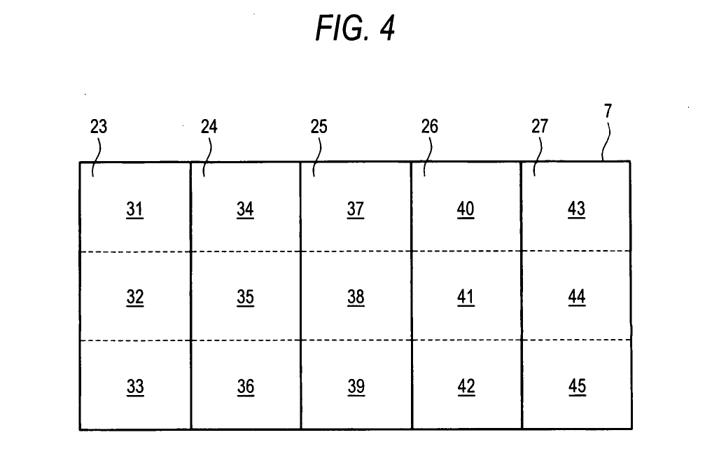

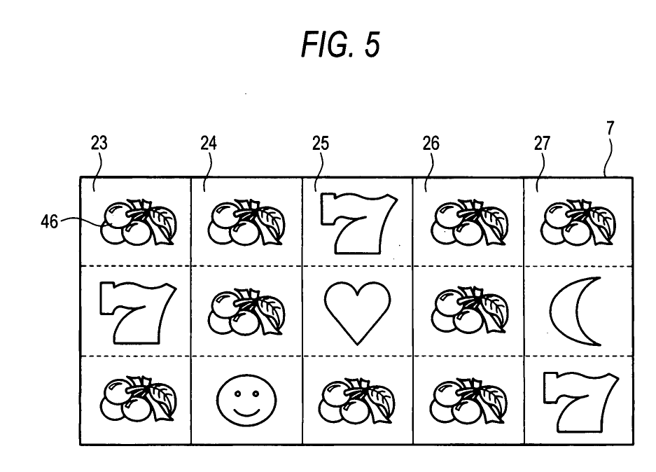

Subsequently, the symbols to be displayed at a gaming time in the symbol display unit 7 of the lower display 6 are described with reference to FIG. 1 and FIG. 4 and FIG. 5. FIG. 4 is a front elevation showing the symbol display unit 7 according to the first embodiment, and FIG. 5 is a front elevation showing the symbols 46 displayed in the symbol display unit 7.

As shown in FIG. 4, the symbol display unit 7 according to the first embodiment is configured of five columns of reels 23 to 27. Moreover, the individual reels 23 to 27 have symbol display areas 31 to 45 for displaying the three symbols 46 individually for the individual reels 23 to 27 when they are stopped in rotations. When the game is started, the symbols 46 (totally fifteen symbols) are displayed individually one for the individual symbol display areas 31 to 45, as shown in FIG. 4. Here, the individual symbol display areas 31 to 45 are so sectioned by dotted lines as to discriminate the individual symbol display areas 31 to 45.

Here in the slot machine 1 according to the first embodiment, the game is played with ten kinds of symbols 46 and blanks (or blank symbols), as shown in FIG. 1. Moreover, a win occurs in the case of a combination, in which a predetermined number or more of symbols of the same kind are displayed independently of the arrangement for the symbol display areas 31 to 45. Then, the award according to the kind and the display number of the symbols is paid out. In the case of a bonus combination, in which the symbols 46 of “7” are arrayed in one transverse row with respect to the symbol display areas 31 to 45, a bonus game is executed as the award continuously from the end of the ordinary game.

In the slot machine 1 according to the first embodiment, the kinds of the symbols, for which the awards are to be paid out, and the upper limit of the symbol number to influence the awards increase, as the number of bets made by the player at the start accepting time, as shown in FIG. 1. For the bet number of 1-BET, for example, the target symbols are four kinds of “CHERRY”, “HEART”, “MOON” and “STAR”. For the bet number of 2-BET, six kinds additionally having symbols of “SUN” and “SMILE” are the targets. For the bet number of 3-BET, eight kinds additionally having symbols of “1BAR” and “2BAR” are the targets. For the bet number of 4-BET, nine kinds additionally having a symbol of “3BAR” are the targets. For the bet number of 5-BET, ten kinds additionally having a symbol of “7” are the targets.

In a case where the bet number is 1-BET, moreover, the credits to be paid out as the award are increased with the symbol number, until the number of the simultaneously displayed symbols is six at the maximum. In a case where the bet number is 2-BET, the credits to be paid out as the award are increased with the symbol number, until the number of the simultaneously displayed symbols is seven at the maximum. In a case where the bet number is 3-BET, the credits to be paid out as the award are increased with the symbol number, until the number of the simultaneously displayed symbols is eight at the maximum. In a case where the bet number is 4-BET, the credits to be paid out as the award are increased with the symbol number, until the number of the simultaneously displayed symbols is nine at the maximum. In a case where the bet number is 5-BET, the credits to be paid out as the award are increased with the symbol number, until the number of the simultaneously displayed symbols is ten at the maximum.

Therefore, the details of the awards vary according to the number of bets made by the player, in a case where the nine symbols 46 of “CHERRY” and the three symbols 46 of “7” are simultaneously displayed, as shown in FIG. 5.

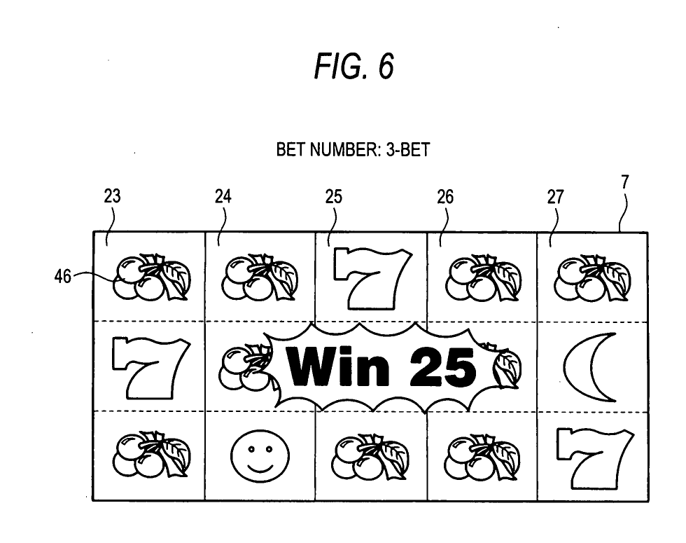

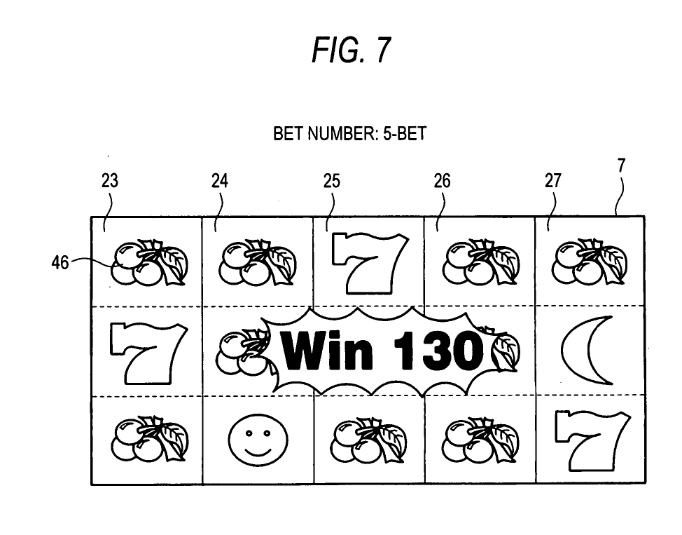

FIG. 6 is a diagram showing the symbol display unit 7 in a state, in which the player starts the game with the 3-BET and in which the symbols 46 are stopped and displayed in the symbol display areas 31 to 45 in the combination shown in FIG. 5. On the other hand, FIG. 7 is a diagram showing the symbol display unit 7 in a state, in which the player starts the game with the 5-BET and in which the symbols 46 are stopped and displayed in the symbol display areas 31 to 45 in the combination shown in FIG. 5.

With the bet number of the 3-BET, as shown in FIG. 1, the symbols “7” are not those (i.e., the specific symbols), to which the awards are paid out. The maximum of the symbols to influence the details of the awards is eight so that the awards of the same details as those in a state, in which eight symbols are displayed, even if nine symbols are displayed. As shown in FIG. 6, therefore, the detail of the award is to pay out 25 credits, as based on the fact that eight symbols of “CHERRY” are simultaneously displayed.

With the bet number of the 5-BET, as shown in FIG. 1, on the other hand, the symbols “7” are those, to which the awards are paid out. The maximum of the symbols to influence the details of the awards is ten. As shown in FIG. 7, therefore, the details of the award is to pay out the sum of 130 credits of the payout of 30 credits, as based on the fact that nine symbols of “CHERRY” are simultaneously displayed, and the payout of 100 credits, as based on the fact that three symbols of “7” are simultaneously displayed.

In the first embodiment, the win occurs and the award is paid out accordingly, when a predetermined number of the specific symbols, such as “CHERRY”, are displayed stopped, as shown in FIG. 1

However, the slot machine 1 may be configured that the win occurs and the award is paid out accordingly, when a predetermined condition is satisfied while the number of the specific symbols being displayed stopped in the arrangement is less than the predetermined number according to the number of bets.

Such predetermined condition may be any one of the follows:

(1) A symbol or a combination of symbols (such as “SMILE”, “HEART”, “MOON”, or a combination of such symbols), which are other than the specific symbol (such as “CHERRY”), are displayed stopped in positions other than the position where the specific symbol are stopped.

(2) A symbol or a combination of symbols (such as “SMILE”, “HEART”, “MOON”, or a combination of such symbols), which are other than the specific symbol (such as “CHERRY”), are displayed stopped in a predetermined positions.

(3) Combination of the above items (1) and (2).

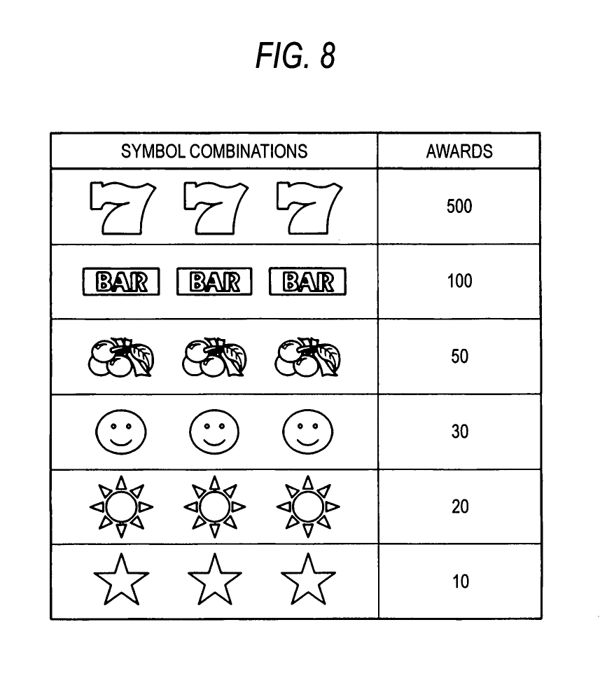

Regarding the wins, the pay lines may be set in the symbol display areas 31 to 45, so that the award may be paid out when the combination of the symbols stopped on the pay line becomes predetermined ones shown in FIG. 8. Still moreover, both the awards, as shown in FIG. 1 and FIG. 8, may also be paid out.

A game advancing procedure of the slot machine 1 according to the first embodiment will be described in detail. At first, when the start button 18 is pressed after the acceptance of a bet is completed, the kinds of the symbols to satisfy the combination to pay out the awards and the maximum of the symbols to influence the details of the awards are determined (as referred to FIG. 1) on the basis of the bet number made by the player. After this, an internal lottery is performed to determine the symbol 46 to be displayed in the symbol display unit 7. At the instant when a predetermined time period elapses after the start button 18 is pressed, the reels 23 to 27 start their rotations thereby to perform the scroll displays of the symbol columns. After lapse of a predetermined time period, the totally fifteen symbols 46 are stopped and displayed for the symbol display areas 31 to 45. Considering the kinds and the maximum of the symbols determined on the basis of the bet number, moreover, the details of the awards are determined and given on the basis of the combination of the symbols stopped and displayed.

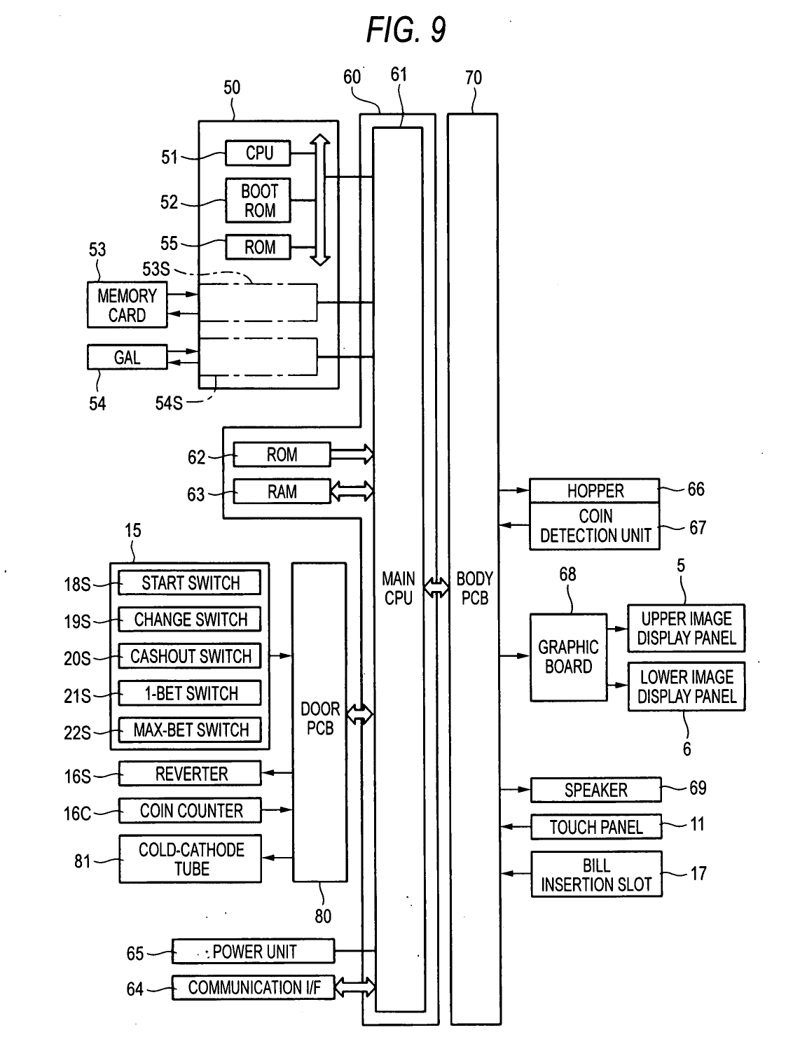

Next, a configuration of the control system of the slot machine 1 according to the first embodiment is described with reference to FIG. 9. FIG. 9 is a block diagram schematically showing the control system of the slot machine 1 according to the first embodiment.

As shown in FIG. 9, the control system of the slot machine 1 is basically configured of a motherboard 60 and a gaming board 50.

The gaming board 50 is provided with: a CPU 51, a ROM 55 and a boot ROM 52 connected with each other through an internal bus; a card slot 53S corresponding to a memory card; and an IC socket 54S corresponding to a GAL (Generic Array Logic) 54.

The memory card 53 is a recording medium, which is configured of a nonvolatile memory and stored with a game program and a game system program (as will be called the “game program and so on”). The game program stored in the memory card 53 contains a lottery program. The lottery program is a program for determining the symbols 46 to be displayed in the symbol display areas 31 to 45.

The memory card 53 also stores a symbol lottery table for drawing the symbols 46 displayed in the symbol display areas 31 to 45. Here, the symbol lottery table is a table, by which a predetermined random number range is made to correspond to the symbols 46 to be stopped and displayed in the symbol display areas 31 to 45. On the basis of the symbol lottery table, moreover, the symbols 46 to be stopped and displayed at first in the symbol display areas 31 to 45 are determined, and the awards to be given to the player are then determined on the basis of the combination of the symbols 46 determined.

The symbol lottery table may be a table, in which the predetermined random number range is made to correspond to the award to be given to the player. In this case, the award to be given to the player is determined on the basis of the symbol lottery table, and the combination of the symbols 46 for satisfying the determined award is selected by a main CPU 61.

The motherboard 61 is configured by using a commercially available motherboard (e.g., a printed circuit board having the fundamental parts of a personal computer mounted thereon), and is provided with the main CPU 61, a ROM 62, a RAM 63 and a communication interface 64.

The ROM 62 is made of a memory device such as a flash memory, and is stored with permanent data such as a BIOS to be executed by the main CPU 61. When the BIOS is executed by the main CPU 61, a predetermined peripheral device is initialized so that the fetch of the game program or the like stored in the memory card 53 is started through the gaming board 50.

The RAM 63 is stored with the data or program to be used when the main CPU 61 acts. Moreover, the RAM 63 can store the various programs such as the authentication program or the game program to be read out through the gaming board 50, or the credit number being owned by the player.

The communication interface 64 is a communication device for performing communications with a server disposed in the game arcade, through communication lines.

A main PCB 70 and a door PCB 80, as will be described hereinafter, are connected with the motherboard 60 through individual USBs. A power unit 65 is also connected with the motherboard 60. When the motherboard 60 is fed with an electric power from the power unit 65, the main CPU 61 starts to operate. The electric power is further fed to the gaming board 50 through the PCI bus so that the CPU 51 is started.

The main PCB 70 is connected with a hopper 66, a coin detection unit 67, a graphic board 68, a speaker 69, the touch panel 11, and the bill insertion slot 17.

The graphic board 68 controls, on the basis of a control signal from the main CPU 61, the image displays in the upper display 5 and the lower display 6. For example, the award display screen 13 (FIG. 3) is displayed on the upper display 5, and the scroll display and the stop display of the symbols 46 accompanying the rotations of the reels 23 to 27 are performed on the lower display 6 for the symbol display unit 7.

The door PCB 80 is connected with the control panel 15, a reverter 16S, a coin counter 16C and a cold-cathode tube 81. The control panel 15 is provided with: a start switch 18S for the start button 18; a change switch 19S for the change button 19; a CASHOUT switch 20S for the CASHOUT button 20; a 1-BET switch 21S for the 1-BET button 21; and a MAX-BET switch 22S for the MAX-BET button 22. These switches output input signals to the main CPU 61 when the corresponding buttons are operated by the player.

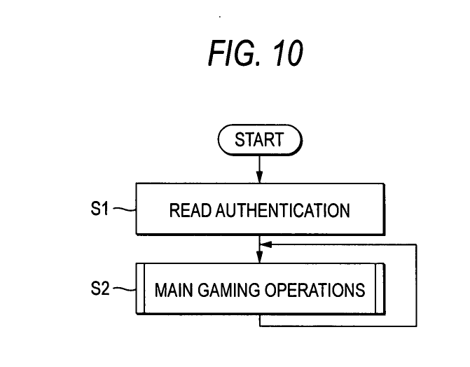

Subsequently, a main control program to be executed in the slot machine 1 according to the first embodiment is described in detail with reference to the accompanying drawings. FIG. 10 is a flow chart of the main control program.

In the slot machine 1, it is assumed that the memory card 53 is already inserted into the card slot 53S of the gaming board 50, and the GAL 54 is mounted in the IC socket 54S.

At first, the power switch is turned on in the power unit 65. Then, the motherboard 60 and the gaming board 50 are individually started to execute the authentication reading operation of Step (as will be abbreviated into “S”) 1. In this authentication reading operation, the motherboard 60 and the gaming board 50 individually perform different operations in parallel.

In the gaming board 50, more specifically, the CPU 51 performs the reading of the preparatory authentication program stored in the boot ROM 52, and performs, in accordance with the read preparatory authentication program, the preparatory authentication to confirm and verify that the authentication program has not been tampered in advance before fetched by the motherboard 60.

In the motherboard 60, the main CPU 61 executes the BIOS stored in the ROM 62, to expand the compressed data installed in the BIOS, into the RAM 63 thereby to execute the BIOS expanded into the RAM 63 and to diagnose and initialize the various peripheral devices.

After this, the main CPU 61 reads out the authentication program stored in the ROM 55, and performs the authentication to confirm and verify that the game program or the like stored in the memory card 53 inserted into the card slot 53S is not tampered. When this authenticating operation normally ends, the main CPU 61 writes the game program or the like to be authenticated (or authenticated), in the RAM 63. Subsequently, the main CPU 61 performs a fetching operation to read out the payout percentage setting data stored in the GAL 54, through the gaming board 50, and writes the payout percentage setting data read out, in the RAM 63.

After these operations, the main CPU 61 ends the authentication reading operation.

At S2, the main CPU 61 sequentially reads out the game program and so on authenticated by the authentication reading operation of the S1, and executes them to perform the main gaming operations. The game in the slot machine 1 according to the first embodiment is played by executing those main gaming operations. Moreover, these main gaming operations are repeatedly executed while the power is being fed to the slot machine 1.

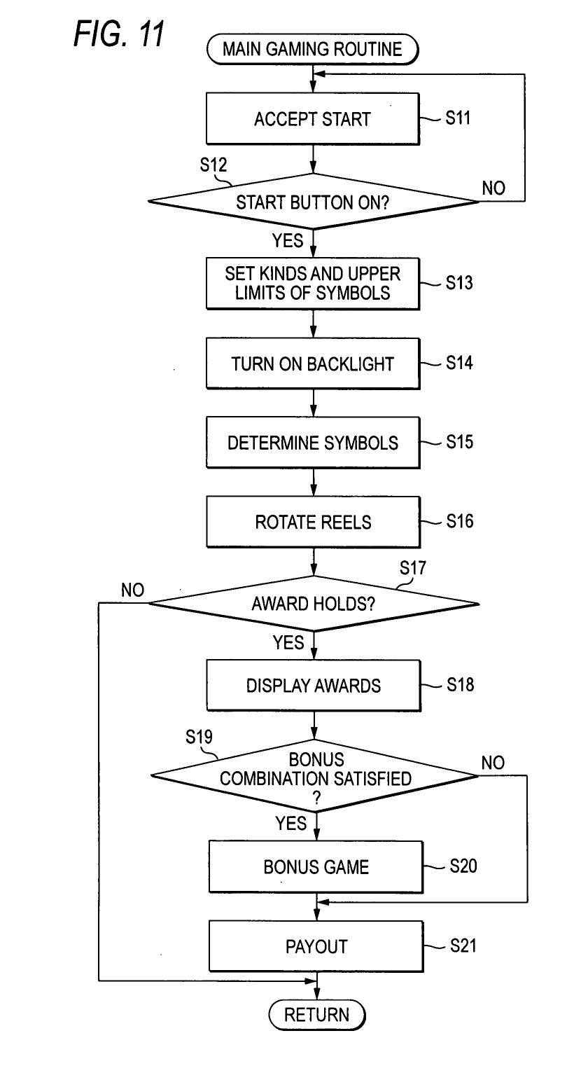

Next, a sub-operation of the aforementioned main gaming operations of S2 is described with reference to FIG. 11. FIG. 11 is a flow chart of the main gaming program in the slot machine 1 according to the first embodiment. Here, the individual programs, as shown in the following flow chart of FIG. 11, are stored in the memory card 53, and are expanded in the RAM 63 belonging to the slot machine 1 so that they are executed by the main CPU 61.

As shown in FIG. 11, at first S11, the main CPU 61 performs a predetermined initial setting, and then a start accepting operation to set the insertion of coins or the bet number. In the initial operation, the data of an item (e.g., the payout number counter) set in a predetermined data area is cleared. In the start acceptance, moreover, the player performs the insertion of coins and a betting operation, by using the 1-BET button 21 and the MAX-BET button 22, to set the bet number of this game to any of the 1-BET to 5-BET.

Next, at S12, the main CPU 61 determines whether or not the start button 18 is pressed. Whether or not the start button 18 is pressed is determined on the basis whether or not the input signal from the start switch 18S has been received.

When the start button 18 is not inputted (S12: NO), the routine returns back to the start acceptance (S11). At this time, the operation to correct the bet number or the like is possible. When the start button 18 is inputted (S12: YES), on the other hand, the bet number, which is set on the basis of the operations of the 1-BET button 21 and the MAX-BET button 22, is subtracted from the owned credit number, and is stored as bet information in the RAM 63.

After this, at S13, the kinds of the symbols, for which the awards are to be paid out, and the upper limit of the symbol numbers to influence the awards are set on the basis of the bet number, which has been accepted by the start accepting operation of S11. When the bet number accepted is 1-BET, for example, the target symbols are four kinds of “CHERRY”, “HEART”, “MOON” and “STAR”, and the upper limit of the symbol number, for which the credits to be paid out as the award increase, is set to six. When the bet number accepted is 2-BET, six kinds additionally having symbols of “SUN” and “SMILE” are the targets, and the upper limit of the symbol number, for which the credits to be paid out as the award increase, is set to seven. When the bet number accepted is 3-BET, eight kinds additionally having symbols of “1BAR” and “2BAR” are the targets, and the upper limit of the symbol number, for which the credits to be paid out as the award increase, is set to eight. When the bet number is 4-BET, nine kinds additionally having a symbol of “3BAR” are the targets, and the upper limit of the symbol number, for which the credits to be paid out as the award increase, is set to nine. When the bent number is 5-BET, ten kinds additionally having a symbol of “7” are the targets, and the upper limit of the symbol number, for which the credits to be paid out as the award increase, is set to ten.

Next, at S14, the main CPU 61 controls the illumination of the backlight of the upper display 5, thereby to light only the award display area 74 indicating the award to be paid out in the award display screen 13 (FIG. 3).

Subsequently, at S15, the main CPU 61 executes a symbol drawing operation to draw the symbols displayed in the individual symbol display areas 31 to 45 of the symbol display unit 7. Specifically, the main CPU 61 executes the random number generating program stored in the lottery program stored in the RAM 63, thereby to sample a random number from the numerical range of a predetermined random number range and to decide the fifteen symbols 46 (i.e., the stop positions of the reels 23 to 27) displayed in the symbol display areas 31 to 45, from a plurality of kinds of symbols, on the basis of the random number sampled and the symbol lottery table.

Next, at S16, the main CPU 61 starts the rotations of the reels 23 to 27, and scrolls and displays the symbol columns arranged in the individual reels 23 to 27, at a predetermined speed. After the predetermined time period elapsed, the reels are stopped and displayed in the order of the reel 23→the reel 24→the reel 25→the reel 26→the reel 27, and the three symbols 46 are displayed individually for the reels 23 to 27 (as referred to FIG. 5).

Subsequently, at S17, the main CPU 61 determines whether or not the combination of the symbols 46 displayed in the symbol display areas 31 to 45 is a specific one for paying out any award.

When determined (S17: YES) that the combination is to pay out the award, the routine transfers to S18. When determined (S17: NO) that the combination is not to pay out the award, on the contrary, the main gaming operation is ended. When the game is next started continuously, the operations of S1 and subsequent steps are performed again.

At S18, the main CPU 61 displays the award based on the combination satisfied in the lower display 6, thereby to report the details of the award to the player. In FIG. 7, for example, the combination, in which the nine symbols of “CHERRY” are displayed and in which the three symbols of “7” are displayed, holds to display the letters “Win 130”, reporting that totally 130 credits are paid out as the award.

Subsequently, it is determined at S19 whether or not the combination of the symbols 46 displayed in the symbol display areas 31 to 45 has held the bonus combination by the first reel revolving operation of S16. Here, the bonus combination is one, in which the symbols 46 of “7” are arrayed in one transverse row.

As a result, the routine proceeds to the bonus game operation (at S20), when it is decided (S19: YES) that the bonus combination has been held. Various modes can be conceived as the bonus game, but the description is made, assuming that the free game is the bonus game. Here, the free game is one, which is played a predetermined number of times with the same details as those of the ordinary game but without any BET. In the bonus game operation of S20, the rotations and stop controls of the reels 23 to 27 are repeatedly performed a predetermined number of times, and the awards held for those repetitions are paid out to the player by the later-described payout of S21. Here, the conditions for the transfer to the bonus game may be either the case, in which a predetermined number or more predetermined symbols are displayed, or the mode, in which the symbols suddenly occur as mysteries, so that they can be set various. Moreover, the lottery table to be used in the free game may also be exemplified by one which is set to have a more payout than that of the ordinary game.

At S21, the main CPU 61 pays out the award based on the combination of the displayed symbol, to the player. At this time, the CASHOUT button 20 is pressed, so that the award can be paid out as the coins (each of which corresponds to one credit) according to the credit number or as the ticket with bar codes.

In the slot machine 1 thus far described according to the first embodiment, the bet number in the game at this time is accepted (at S11) at any of 1-BET to 5-BET by the operation of the player at the game starting time using the 1-BET button 21 and the MAX-BET button 22. On the basis of the bet number accepted, the kinds of the symbols to be paid out for the awards and the upper limit of the symbol number to influence the awards are set (at S13). After this, the reels 23 to 27 start their individual rotations, and the totally fifteen symbols 46 are stopped and displayed for the symbol display areas 31 to 45 after lapse of a predetermined time period, so that the awards are paid out (at S21) to the player on the basis of the kinds of the set symbols, the upper limit of the symbol numbers and the combination of the arranged symbols 46. This makes it possible to increase the patterns to be held by the combinations to pay out the awards, and to increase the combinations of the symbols to give an award of a larger sum. Thus, the expectations for the game can be improved to provide an attractive game for the player.

By increasing the bet number, moreover, the kinds of the symbols to be paid out for the awards and the upper limit of the symbol numbers to influence the awards can be increased to allow the player to enjoy the game with a larger number of bets.

### SECOND EMBODIMENT

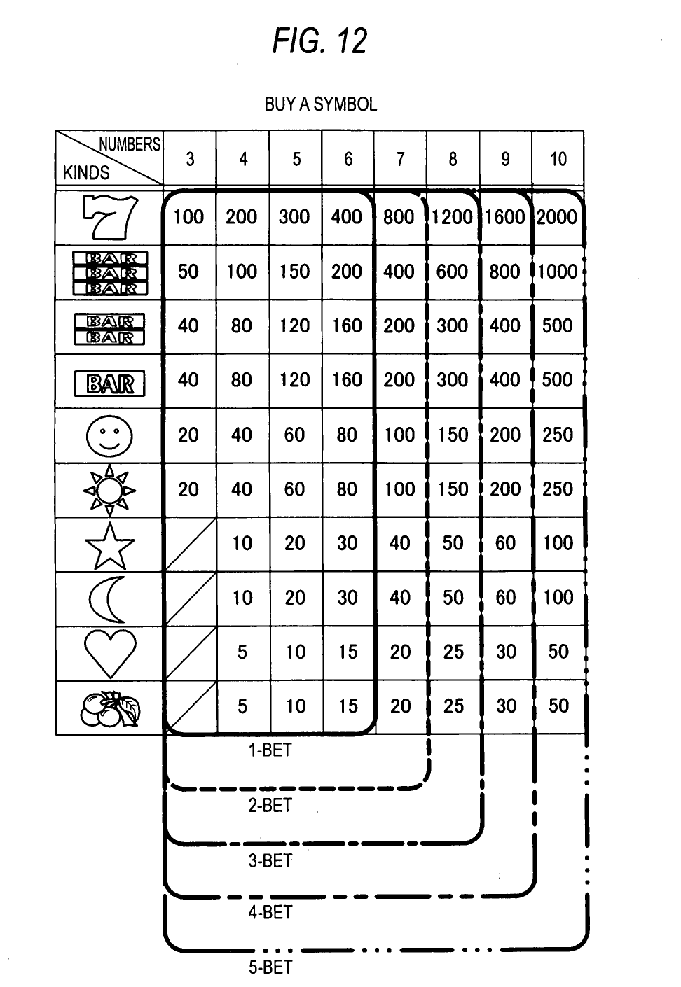

Next, a slot machine according to a second embodiment is described with reference to FIG. 12. In the following description, the same reference numerals as those of the configuration of the slot machine 1 according to the first embodiment of FIG. 1 to FIG. 11 designate the same or corresponding portions as or to the configuration of the slot machine 1 or the like according to the first embodiment.

The schematic configuration of the slot machine according to the second embodiment is substantially identical to that of the slot machine 1 of the first embodiment. Moreover, the various control operations are also substantially identical to those of the slot machine 1 of the first embodiment.

In the slot machine 1 according to the first embodiment, however, both the kind of the symbols to be paid out and the upper limit of the symbol numbers to influence the awards are modified according to the bet numbers accepted. On the other hand, the slot machine according to the second embodiment is different from the slot machine 1 according to the first embodiment in that the upper limits of the symbol numbers to influence the awards are exclusively modified by the bet numbers accepted.

In the slot machine according to the second embodiment, as shown in FIG. 12, the credits to be paid out as the awards so increase with the symbol number that the number of the symbols simultaneously displayed for the symbols of totally ten kinds becomes six at the maximum. When the bet number is 2-BET, the credits to be paid out as the awards so increase with the symbol number that the number of symbols simultaneously displayed becomes seven at the maximum. When the bet number is 3-BET, the credits to be paid out as the awards so increase with the symbol number that the number of symbols simultaneously displayed becomes eight at the maximum. When the bet number is 4-BET, the credits to be paid out as the awards so increase with the symbol number that the number of symbols simultaneously displayed becomes nine at the maximum. When the bet number is 5-BET, the credits to be paid out as the awards so increase with the symbol number that the number of symbols simultaneously displayed becomes ten at the maximum.

In the payout (at S21), the main CPU 61 decides the details of the awards to be paid out to the player, on the basis of the upper limits of the symbol numbers set on the basis of the bet numbers accepted, and the combination of the symbols 46 displayed in the symbol display areas 31 to 45.

In the slot machine 1 according to the second embodiment, as has been described hereinbefore, the bet number in the game at this time is accepted (at S11) as any of 1-BET to 5-BET by the operations of the player using the 1-BET button 21 and the MAX-BET button 22 at the game starting time. The upper limit of the symbol numbers to influence the awards is set on the basis of the bet number accepted. After this, the reels 23 to 27 start their rotations, and the totally fifteen symbols 46 are stopped and displayed after lapse of a predetermined time period for the symbol display areas 31 to 45, so that the awards are paid out (at S21) to the player on the basis of the upper limit of the set symbol number and the combination of the symbols 46 arranged. This can increase the combinations of the symbols to pay out the awards of the larger sums. As a result, it is possible to improve the feeling of expectation for the play thereby to provide a game attractive for the player.

### Third Embodiment

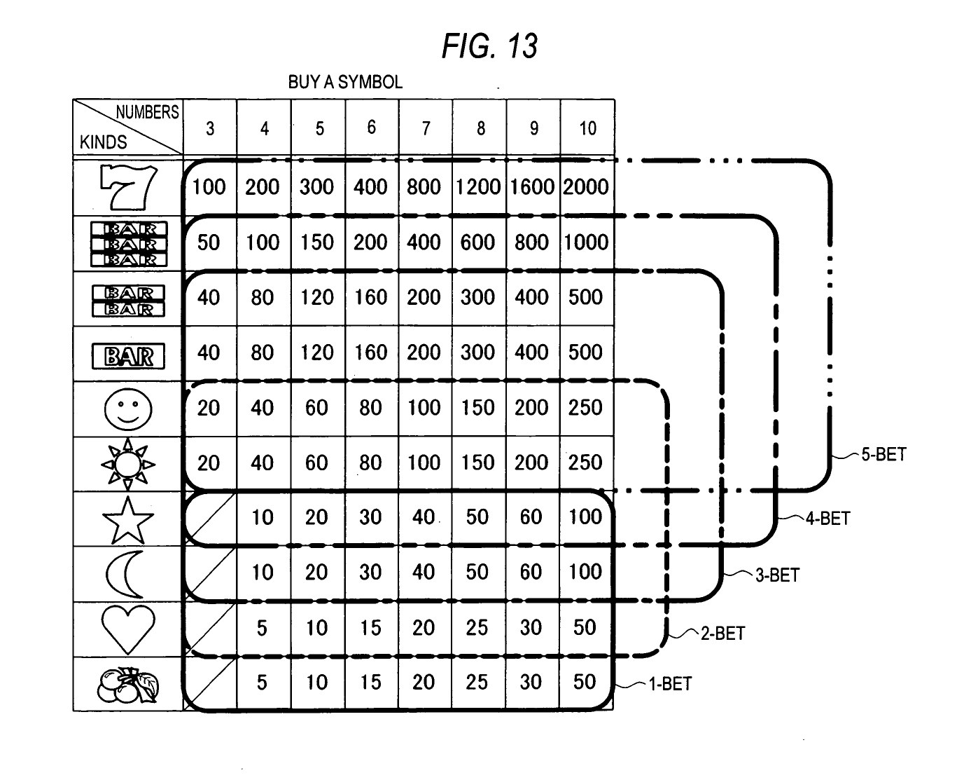

Next, a slot machine according to a third embodiment is described with reference to FIG. 13. In the following description, the same reference numerals as those of the configuration of the slot machine 1 according to the first embodiment of FIG. 1 to FIG. 11 designate the same or corresponding portions as or to the configuration of the slot machine 1 or the like according to the first embodiment.

The schematic configuration of this slot machine according to the third embodiment is substantially identical to that of the slot machine 1 of the first embodiment. Moreover, the various control operations are also substantially identical to those of the slot machine 1 of the first embodiment.

In the slot machine 1 according to the first embodiment, however, the kind of the symbols to be paid out and the upper limit of the symbol numbers to influence the awards increase as the bet numbers accepted increase. On the other hand, the slot machine according to the third embodiment is different from the slot machine 1 according to the first embodiment in that the kinds of the symbols to be paid out for the awards do not simply increase but are modified in their combinations, as the bet numbers accepted increase.

In the slot machine according to the third embodiment, when 1-BET is accepted as the bet number in the start accepting operation (at S11), as shown in FIG. 13, four kinds of symbols of “CHERRY”, “HEART”, “MOON” and “STAR” are the targets, and the credits to be paid out as the awards increase according to the symbol number, until the number of symbols simultaneously displayed is ten at the maximum. When the bet number is 2-BET, five kinds of “HEART”, “MOON”, “STAR”, “SUN” and “SMILE” are the targets. When the bet number is 3-BET, six kinds of “MOON”, “STAR”, “SUN”, “SMILE”, “1-BAR” and “2-BAR” are the targets. When the bet number is 4-BET, six kinds of “STAR”, “SUN”, “SMILE”, “1-BAR”, “2-BAR” and “3-BAR” are the targets. When the bet number is 5-BET, six kinds of “SUN”, “SMILE”, “1-BAR”, “2-BAR”, “3-BAR” and “7” are the targets.

In the payout (at S21), the main CPU 61 decides the details of the awards to be paid out to the player, on the basis of the kinds of the symbols to be paid for the awards set on the basis of the bet numbers accepted, and the combination of the symbols 46 displayed in the symbol display areas 31 to 45.

In the slot machine 1 thus far described according to the third embodiment, the bet number in the game at this time is accepted (at S11) at any of 1-BET to 5-BET by the operation of the player at the game starting time using the 1-BET button 21 and the MAX-BET button 22. On the basis of the bet number accepted, the kinds of the symbols to be paid out for the awards are set. After this, the reels 23 to 27 start their individual rotations, and the totally fifteen symbols 46 are stopped and displayed for the symbol display areas 31 to 45 after lapse of a predetermined time period, so that the awards are paid out (at S21) to the player on the basis of the kinds of the set symbols and the combination of the arranged symbols 46. This makes it possible to change the patterns to be satisfied by the combinations to pay out the awards. Thus, the expectations for the game can be improved to provide an attractive game for the player.

By increasing the bet number, moreover, the kinds of the symbols to be paid out for the awards can be modified those of the symbols for the payout of a larger sum, thereby to allow the player to enjoy the game with a larger number of bets.

Here, the present invention should not be limited to the aforementioned embodiments but can naturally be improved and modified in various manners within the scope not departing from the claimed invention.

In the first to third embodiments, for example, as the bet number accepted increases, the kinds of the symbols or the targets to be paid out for the awards increase or vary according to the preset rules (as referred to FIG. 1 and FIG. 13), but the kinds of symbols to be increased may also be selected by the player. In this case where the bet of 2-BET or larger is accepted after the end of the bet acceptance (at S11), the list of symbols may be displayed in the lower display 6 so that the player is enabled to select the symbols by using the touch panel.

In the first to third embodiments, the kind of the symbols to be paid out for the awards and the upper limit of the symbols to influence the awards are modified under the condition that the bet numbers accepted increase, but the condition may be other than the bet numbers. When the payout percentage becomes 90% or less, for example, it is possible to increase the kinds of the symbols to be paid out for the awards and the upper limit of the symbols to influence the awards. When the payout percentage becomes 95% or more, it is also possible to decrease the kinds of the symbols to be paid out for the awards and the upper limit of the symbols to influence the awards. When the combination of the symbols becomes a predetermined one, moreover, it is further possible to increase the kinds of the symbols to be paid out for the awards and the upper limit of the symbols to influence the awards for several games.

The present invention can also be applied to the slot machine using mechanical reels. The present invention should not be limited to the slot machine but can be extended to a poker game machine, for example. In this case, it is possible to modify the symbols (e.g., 3 of hearts) that satisfy the combination (i.e., a poker hand) to be awarded according to the bet number of the player or the upper limit of the card number.

For example, the targets of the cards for satisfying the hands can be only the symbols of the hearts, when the game is started with the 1-BET. The targets of the cards for satisfying the hands can also be all the symbols, when the game is started with the 4-BET or more. When the game is started with the 1-BET, the targets of the awards are set to three sheets even if four or more identical symbols are displayed (that is, the award for the three-card hand is paid out even when the four-card hand holds). When the game is started with the 5-BET, a higher award (i.e., an award for the four-card hand) corresponding to the display of the four cards may be given if the four cards of the common symbol are displayed.

As described above with reference to the embodiments, there is provided a gaming machine and a method that provide a game, in which the upper limit of the number of the specific symbols to influence the details of the awards is modified to increase the patterns of the combination to give an award of a larger sum, so that a game attractive for the player can be provided. This improves the expectation for the game.

As the number of bets accepted increases, moreover, the upper limit of the number of the specific symbols to influence the details of the awards is increased, so that the player can play with larger bet numbers.

Moreover, not only the upper limit of the number of specific symbols to influence the details of the awards but also the kinds of the specific symbols to satisfy the combination to pay out the awards are modified to change the patterns, in which combinations to give awards of larger sums hold. It is, therefore, possible to provide a game attractive for the player can be provided.

It is described in the embodiment that the award is “paid out” to the player in accordance with the combination of the symbols displayed stopped in the second arrangement. However, the award may be any type of award that is advantageous to the player in playing the game.

The award may be provided to the player by providing the player a bonus game such as a free game, which is played without consumption of any game medium (coins, medals, tokens, or credits), or a second game, which is different from the base game and is more advantageous to the player.

The award may also be provided to the player by transitioning the game to be performed based on an award table having higher odds than the award table shown in FIG. 5 used in the base game.

The award may also be provided to the player by actually paying out tangible game medium (coins, medals, or tokens) to the player, or by paying out non-tangible credits as the game medium to the player. The credits may be accumulated in the gaming machine to be actually paid out later as the tangible game medium.

As described with reference to the embodiments, there is provided a gaming machine including: a display; an operation unit that allows a player to input commands for playing a game; and a processor that is operable with the display and the operation unit to: control the display to display an arrangement of a plurality of symbols for providing the game, the symbols each belonging to one of a plurality of kinds; pay out an award to the player when the arrangement is determined to be a combination including a predetermined number of symbols that belong to a kind that is defined as a specific symbol, the award having a detail being determined in accordance with the number of the symbols, which belong to the kind that is defined as the specific symbol, included in the arrangement; and change an upper limit of the number of the symbols when a predetermined condition is satisfied.

There is also provided a method for providing a game to a player, the method including: allowing the player to input commands for playing the game; displaying an arrangement of a plurality of symbols for providing the game, the symbols each belonging to one of a plurality of kinds; paying out an award to the player when the arrangement is determined to be a combination including a predetermined number of symbols that belong to a kind that is defined as a specific symbol, the award having a detail being determined in accordance with the number of the symbols, which belong to the kind that is defined as the specific symbol, included in the arrangement; and changing an upper limit of the number of the symbols when a predetermined condition is satisfied.

What is claimed is:

1. A gaming machine comprising:
a display;
an operation unit that allows a player to input commands for playing a game; and
a processor that is operable with the display and the operation unit to:
control the display to display an arrangement of a plurality of symbols for providing the game, the symbols each belonging to one of a plurality of kinds;
provide an award to the player when the arrangement is determined to be a combination including a predetermined number of symbols that belong to a kind that is defined as a specific symbol, the award having a detail being determined in accordance with the number of the symbols, which belong to the kind that is defined as the specific symbol, included in the arrangement; and
change an upper limit of the number of the symbols when a predetermined condition is satisfied.

2. The gaming machine according to claim 1, wherein the processor further operates to:
accept a bet made by the player through the operation unit; and
determine the detail of the award further in accordance with the bet.

3. The gaming machine according to claim 2, wherein the processor changes the upper limit of the number of the symbols based on a number of the bet made by the player through the operation unit.

4. The gaming machine according to claim 3, wherein the processor changes to increase the upper limit of the number of the symbols as the number of the bet made by the player through the operation unit increases.

5. The gaming machine according to claim 2, wherein the processor changes the upper limit of the number of the symbols when a number of the bet made by the player through the operation unit reaches to a predetermined number.

6. The gaming machine according to claim 1, wherein the display includes a display panel that displays various images on a screen, the images including a plurality of video reels on which the symbols are arranged.

7. The gaming machine according to claim 1, wherein the display includes a plurality of mechanical reels on which the symbols are arranged.

8. A method for providing a game to a player, the method comprising:
allowing the player to input commands for playing the game;
displaying an arrangement of a plurality of symbols for providing the game, the symbols each belonging to one of a plurality of kinds;
providing an award to the player when the arrangement is determined to be a combination including a predetermined number of symbols that belong to a kind that is defined as a specific symbol, the award having a detail being determined in accordance with the number of the symbols, which belong to the kind that is defined as the specific symbol, included in the arrangement; and
changing an upper limit of the number of the symbols when a predetermined condition is satisfied.

9. The method according to claim 8 further comprising:
accepting a bet made by the player; and
determining the detail of the award further in accordance with the bet.

10. The method according to claim 9, wherein the upper limit of the number of the symbols is changed based on a number of the bet made by the player.

11. The method according to claim 10, wherein the upper limit of the number of the symbols is changed to increase as the number of the bet made by the player increases.

12. The method according to claim 9, wherein the upper limit of the number of the symbols is changed when a number of the bet made by the player reaches to a predetermined number.
